(19) United States
(12) Patent Application Publication
(10) Pub. No.: US 2009/0135999 A1
(43) Pub. Date: May 28, 2009

(54) Composite Housing and Structural Support for Digital X-Ray Receptor

(76) Inventor: J. Albert McEachern, JR., Mobile, AL (US)

Correspondence Address: J. Albert McEachern, Jr., 5815 I-10 Industrial Parkway South, Theodore, AL, 36582, US

(21) Appl. No.: 11/848,829

(22) Filed: Aug. 31, 2007

(51) Int. Cl. H05G 1/64

(52) U.S. Cl. 378/98.2

(57) ABSTRACT

A receptor for a Digital Radiographic system of the type having a digital camera 15, a lens 14, a phosphor screen 11, and a structural housing 10. The housing is constructed using a resin based composite with fiber or other reinforcement and may incorporate layers designed to affect the rigidity and structural integrity of the structure, alignment of the components, or to provide impervious protection of the optical path from foreign substances, light or other forms of radiation.

### CROSS-REFERENCE TO RELATED APPLICATIONS

Not Applicable

### FEDERALLY SPONSORED RESEARCH

Not Applicable

### BACKGROUND OF THE INVENTION

1. Field of Invention

This invention relates to a digital imaging device using X-Rays or other radiation to penetrate the subject and using Digital Camera technology to capture the image for viewing, specifically to such machines that require the alignment and support of internal components as well as an exterior housing to protect said components from the environment and light contamination. This invention employs the use of resin bonded composite structures to meet those requirements.

2. Background of the Invention

Conventional X-Ray systems used for medical, veterinary, NDT inspection, drug interdiction, and many other diagnostic and scientific purposes use a device that generates a burst of X-Ray energy which is used to penetrate the subject and expose a photographic plate or film placed behind the subject. The image that is produced on the plate or film is representative of the density and X-Ray permeability of the subject and has long been used for a multitude of diagnostic and/or investigative applications. With the advent of digital computers and digital imaging, several technologies have emerged which seek to eliminate the use of the chemical photographic plate and to provide a high quality digital image. This invention relates to the digital X-Ray systems which use a phosphor imaging screen that absorbs the X-rays and fluoresces to generate visible light. The light from the phosphor screen is then reflected and refracted by a combination of mirrors and lenses to focus the image on a digital camera chip, or other similar digital imaging device which stores the image in a digital format in the memory of a computer. Special software is used to process, store and display the image. One example of this kind of system is shown in U.S. Pat. No. 6,546,076B1 entitled “DIGITAL HIGH RESOLUTION X-RAY IMAGING UTILIZING AN IMAGING SENSOR.” This and other systems have demonstrated the many advantages to digital X-Ray systems including:
a. Near instant presentation of the image on a computer screen. This allows the physician or other professional to evaluate immediately the image generated and to determine if an adjustment or additional exposure is required. It should be noted that multiple images can easily be made without the additional cost of film, developing chemicals, a dedicated wet chemical laboratory and the services of a trained technician for developing the films.
b. Decrease in the cost of storage. Since many images can be stored on a hard disk, or on other bulk media available today at a very low cost, archiving the images no longer will require the space and staff to maintain a large data base containing thousands of images.
c. Digital images can also be easily transmitted by email or other internet based media for consultation or evaluation by other professionals.
d. Using special software, radiologists or other professionals using the system can manipulate the image in several ways to enhance particular qualities or nuances in the image digitally thereby improving the diagnostic or analytic ability of the imaging process.
e. Diagnostic images can be easily incorporated into Electronic Healthcare Record systems, stored and recalled electronically along with the other medical data using approved methods of encryption and other privacy safeguards to meet current and future standards.

The alignment of the mirror(s), the phosphor screen, and the digital camera is critical for obtaining high quality, clear images. In prior art, a metallic framework, primarily aluminum, is used to hold the optical components in alignment. This skeletal frame adds significantly to the weight of the digital X-Ray receptor and is expensive to fabricate and assemble.

Furthermore, due to the relatively low elastic modulus of Aluminum, a large bulky frame is required to hold the components in place, maintain the precise optical path, and prevent vibration from blurring the image. Metallic structures using a higher modulus material such as steel would increase the weight of the receptor and therefore require an even more robust structure to meet the stiffness requirements. The added weight, in turn, requires a larger, bulkier fixture or stands to support the receptor.

Moreover, in addition to the skeletal structure used to support the optical components, an enclosure or cover is required to protect the internal components from the environment. Medical, veterinary, and industrial X-Ray systems are exposed to many environmental factors and hazards which can contaminate the optical path and result in degraded image quality. Prior art machines have used sheet metal covers as well as molded plastic covers to exclude dust, dirt, liquids, corrosive vapors and other contaminants which are detrimental to the optical components in the system. These covers must be mounted on the metallic skeletal framework and sealed at all edges and wherever fasteners are used. It is highly desirable in most environments where X-Ray machines are used for wash down procedures to be permitted for cleaning and sanitizing the equipment. Multiple fasteners, joints and seals make it difficult to develop wash down procedures due to the risk of contaminating the internal components.

Therefore, the disadvantages of the skeletal structure used in referenced patents and in current production machines include:
a. Excess weight of the digital X-Ray receptor due to the use of the metal structure, fasteners, and redundant cover.
b. High expense of the precision machined skeletal frame.
c. Difficult light and contaminant sealing of cover and many fasteners required to mount cover on frame.
d. Difficult to clean and sterilize.

### BACKGROUND OF THE INVENTION

### Objects and Advantages

In this invention, the structural support for the digital X-ray receptor is comprised of a composite structure which provides both a rigid mounting for the optical components and a tightly sealed compartment that excludes contaminants. The composite structure consists of a combination of resin, high strength and/or modulus fibers oriented to optimize the stiffness of the structure where it is required, low density core materials, and other layers as required for the performance of the structure in its environment. The load-bearing fibers can be oriented to maximize performance, and can be selected from different materials such as glass, carbon, or metals such as boron to obtain the desired properties, principally the stiffness and strength to maintain alignment of the optical elements in the digital X-ray receptor. These layers may also include a highly moisture and abrasion resistant exterior, high performance cloth, mat, or roving, core material, radiation shielding, or energy absorbing materials as required. The external housing may be also integrated into a single molded component with the structural support system.

The housing and structural system may be manufactured using a mold or molds which will assure a high degree of dimensional accuracy and repeatability. This will minimize the need for adjustment of the alignment of the optical components during assembly. Conventional hand lay up procedures can be used to fabricate the housing. However, the method of pre-assembling the core and fibrous structural and other layers is preferred. With this method, after the pre-assembly of the prescribed layers, a vacuum is applied to the mold to remove all air and vapors. The thermo set resin is infused through ports provided in the mold. Since there is no air in the mold, bubbles and voids are eliminated and the vacuum compresses the fiber components to achieve a very high fiber/resin ratio. This assures the maximum mechanical properties of the composite structure and therefore a light weight, highly rigid structure. Other means including the use of pre-impregnated materials, pre-fabricated cored panels, injection molding and proprietary processes may be used to create the composite housing/structure.

Thus, the following objects and advantages are provided by this invention:
a. A substantial decrease in cost for digital X-Ray systems due to lower manufacturing cost. This will improve the overall cost and quality of health care.
b. A significant decrease in the weight of the digital X-Ray receptor is experienced as a result of this invention. This makes the effort on the part of the technician positioning the subject and the receptor much easier.
c. The lighter weight also makes holding and positioning the receptor less cumbersome and more easily accomplished with lighter and less expensive stands or fixtures. Since the digital X-Ray system replaces the film cassette with the receptor, the light weight composite digital receptor is capable, in some cases of being retrofitted to the existing fixtures designed for film cassettes.
d. Due to the repeatability of the molding process, the composite structure can achieve a higher degree of accuracy for alignment of the optical components. This results in lower manufacturing time and better field reliability.
e. The composite structure and housing can be manufactured at a substantially lower cost than the system using a metallic frame.
f. Due to the inherent continuity of the shell of the composite structure, cleaning, wash down, sterilization and protection of the interior components from the environment are greatly enhanced.
g. The elimination of the metal frame also improves the image quality by removing one the sources of backscatter noise.

### SUMMARY OF THE INVENTION

The digital X-Ray receptor uses a fiber reinforced composite structure to rigidly align and support the optical components of the machine and to simultaneously enclose the components to protect them form environmental contaminants.

### BRIEF DESCRIPTION OF THE DRAWINGS

FIG. 1a is an overall view of the digital X-Ray receptor in the preferred embodiment using a single camera and two mirrors.

FIG. 1b shows a cutaway view of a single camera, two mirror arrangement with the preferred embodiment of the invention. The resin bonded composite housing (1) serves as the primary structural support for the phosphor screen (2), the primary mirror (3), secondary mirror (4), lens assembly (5), and camera assembly (6).

FIG. 2. represents a single mirror, single camera configuration.

FIG. 3 is a depiction of a single camera system without mirrors. A special lens is used to protect the camera from direct radiation, but to admit visible light.

### DETAILED DESCRIPTION

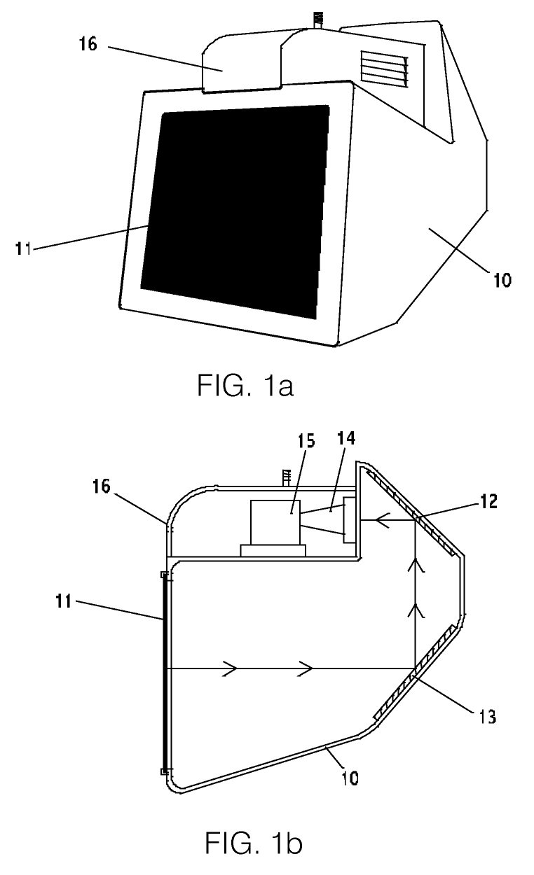

### FIGS. 1a and 1b—Preferred Embodiment

A preferred embodiment of an integral housing/structure for a Digital X-Ray Receptor is illustrated in FIG. 1a and in cross section in FIG. 1b. The integral housing/structure 10 is constructed using a resin based composite material with layers of fibers in the form of roving, mats, woven cloth or other arrangements along with relatively light weight core materials such as plastic foam, metallic or plastic honeycomb or balsa wood. The composite may be constructed using a mold or by assembling pre-formed panels. If a mold is used, the layers are put into place during the molding process by the hand lay up process, spraying, or assembled dry and infused using a vacuum infusion process. Pre-impregnated materials may also be used in the process. In some cases, a pre-mixed composite can be cast or injection molded to achieve the desired properties. The various types of layers are designed to provide a high modulus of elasticity in the structure oriented in selected directions in the structure where the property of high stiffness is advantageous to the stability of the structure and the minimal weight possible. Orientation of the layers to coincide with specific stresses significantly reduces deflection that would affect the alignment of the components and therefore the image quality. The result of this design is to provide a light weight housing/structure 10 with a very high stiffness and stability to maintain alignment of the components. Where other properties are required, the layers are modified to provide the desired property. For example, to make the exterior surface smooth, attractive, water proof and damage or abrasion resistant, a hard layer commonly referred to as a gel coat is used. Mounting and attaching points in the structure can be reinforced internally with heavier core materials, metal inserts, ribs, or pieces of various materials with specially selected properties. Where control of stray, reflected or scattered radiation is required, a layer will be added using a radiation absorbing barrier material such as lead. Should any material such as lead be used which has potential for toxicity or other adverse properties, the hazardous layer can be located inside the composite sandwich thus encapsulating the said hazardous layer rendering it safe, but retaining the desired protective property of the radiation barrier.

A phosphor screen 11 is mounted in the large opening to the housing/structure 10 and sealed to the housing at its perimeter. Mirrors 12 and 13 are mounted on the interior surfaces of the said housing/structure 10 and carefully aligned to transmit the image clearly and accurately from the phosphor screen 11 to the lens 14 and digital camera 15 where the image is captured.

Said lens 14 is mounted firmly and sealed to the housing/structure forming an air and dust tight enclosure in the volume bounded by the phosphor screen 11, the lens 14 and the housing/structure 10. The mirrors 12 and 13 are contained in the sealed space. The enclosure also excludes any ambient light that would affect the image quality produced by the camera.

A cover 16 with openings for air circulation is provided to protect the camera from mechanical damage, provide a pleasing exterior appearance and to exclude dirt or liquids that might damage the fan, cooling system or the camera. The said openings are to provide circulation of cooling air to the camera.

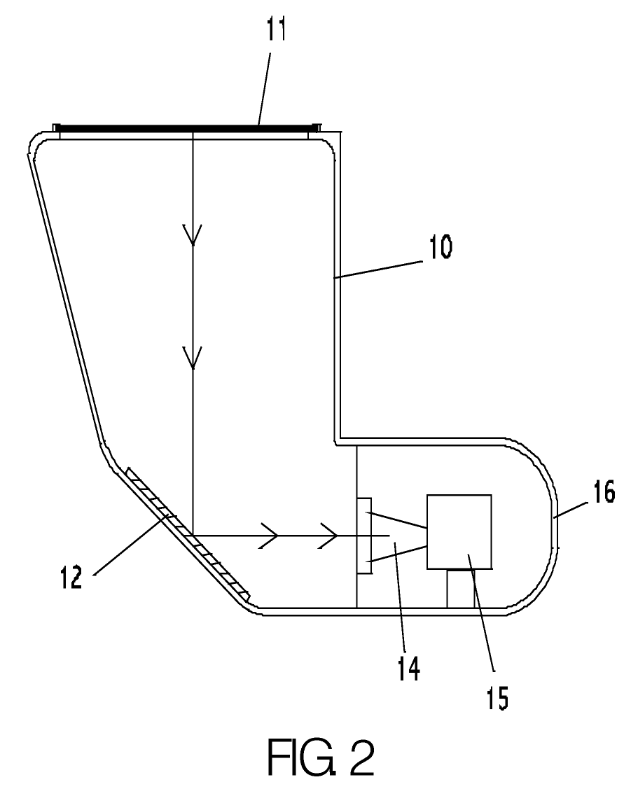

### FIGS. 2 & 3—Additional Embodiments

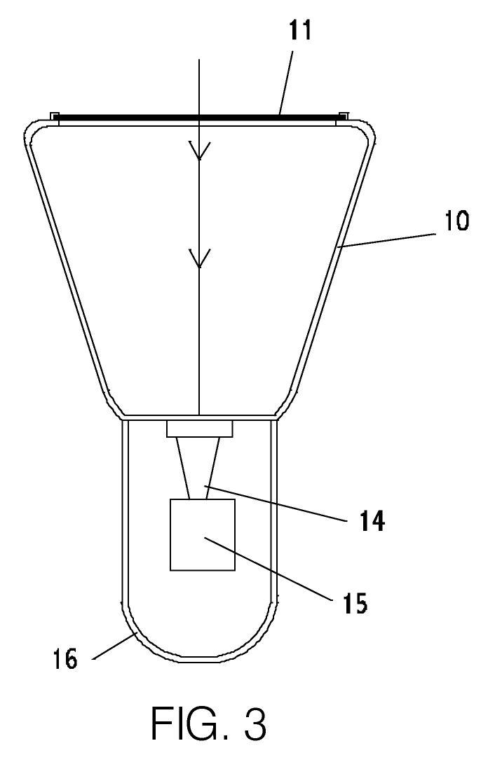

The embodiment illustrated in FIG. 2 uses a single mirror 12 direct the image from the phosphor screen 11 to the lens 14 and digital camera 15. In FIG. 3 The camera 15 and lens 14 are aligned to view the phosphor screen 11 directly. Various configurations of digital imaging devices are possible using a plurality of mirrors, cameras, and other equipment to be mounted in and on the composite structure that is the embodiment of this invention.

### Advantages

(a) A remarkable decrease in weight results from the proper use of a composite structure for the digital imaging receptor. Since the objective of the structure is to maintain the alignment and position of the elements, use of materials with higher modulus reduces the section area required to obtain the same stiffness. Since the weight of the structure decreases along with the section area, further decreases in section area are possible since the load due to the weight of the structure itself has decreased.
(b) With the advantages of digital imaging previously discussed, a significant decrease in manufacturing cost resulting from the use of a composite structure will allow a much wider application of digital imaging in both the medical and industrial applications.
(c) Improved control of the geometry of the light path from the phosphor screen to the camera improves image quality.
(d) The composite structure can be constructed as an integral unit with the housing resulting in improved sealing of the interior light path. This improves image quality further due to a decrease in light leakage.
(e) The improved structure with better sealing also facilitates cleaning, sterilization and protects the light path from harsh environments.
(f) The light weight structure will require less cumbersome support structures This will also decrease the overall cost of the system.
(g) The overall appearance of the receptor using this invention is very clean and attractive which is very important in the medical fields.

### CONCLUSION, RAMIFICATIONS, AND SCOPE

This invention offers a multitude of advantages to the manufacturing of digital imaging equipment. Since any decrease in weight of the structure results a further decrease in structural support requirements. The benefits of this manufacturing method are remarkable particularly when high performance composites using specialty fibers and very light weight cores are used. The inherent accuracy of precision molding further decreases the cost of manufacturing and assembly of the systems.

Although the description above contains many specifics, these should not be construed as limiting the scope of the invention but merely providing illustrations of some of the preferred embodiments of the invention. For example combinations of composite structure and metal reinforcements can be used to achieve an optimum configuration for a particular application. Radical advancements in the technology of digital cameras, phosphor screens and imaging software are taking place. It is expected that this invention will compliment the new technology.

Thus the scope of the invention should be determined by the appended claims and their legal equivalents, rather than by the examples given.

I claim:

1. A receptor for a digital imaging system using penetrating radiation passing through an object or person for diagnostic or investigative purposes comprising:
a) a phosphor screen that absorbs the radiation and emits visible light creating an image,
b) a lens that collects the light and focuses the image,
c) a digital camera that captures and records the image in a format suitable for viewing using a computer and suitable software, and
d) a resin based composite structure to support and align said phosphor screen, lens, and digital camera.

2. The digital imaging receptor of claim 1 where a mirror or a plurality of mirrors is used to convey the image from the phosphor screen to the lens and camera and where the said resin based composite structure is used to support and align the mirror or mirrors.

3. The digital imaging receptor of claim 1 where said resin based composite structure is integrated totally or partially with the enclosure housing used to exclude light and foreign material from the space inside the receptor.

4. The digital imaging receptor of claim 1 where said resin based composite structure is constructed using pre manufactured; cored composite panels bonded by thermo set resins reinforced with high strength and high modulus fibers.

5. The digital imaging receptor of claim 1 where said resin based composite structure is manufactured using a mold and comprises a plurality of layers which may include:
a) a thermo set or thermo plastic resin,
b) reinforcing fibers made of glass, high strength polymers, carbon, or metals such as boron in the form of roving, mats, or woven cloth oriented to provide high strength and stiffness to the structure in the areas where these properties are necessary to maintain the accurate alignment of the components under all normal operating conditions,
c) core materials such as plastic foam, honeycomb, or balsa wood,
d) layer or layers impervious and resistant to liquids, gases, vapors, various kinds of radiation including visible light, or other forms of contamination detrimental to the performance of the receptor. An example given might be a gel coat to provide a water tight structure and a pleasing exterior,
d) inserted pieces of material for attachments, reinforcing ribs, or other dimensional features,
e) layer or layers with special radiological properties such as lead to absorb excess or stray radiation to reduce errant emissions, and

6. the digital imaging receptor of claim 5 where the said resin based composite is manufactured in a mold where the volume containing the said reinforcing fibers, core materials and inserted pieces can be placed in the mold, the mold sealed by various methods and evacuated to remove the air in the mold after which the liquid resin is injected to fill the evacuated space.

7. The digital imaging receptor of claim 1 where said resin based composite is manufactured in a mold by casting or injection molding.

8. The digital imaging receptor of claims 1 and 3 where said resin based composite structure is partially or totally integrated with the enclosure housing and constructed of one or more pieces bonded or connected with fasteners in the final assembly.
